(19) United States
(12) Patent Application Publication
(10) Pub. No.: US 2021/0260665 A1
(43) Pub. Date: Aug. 26, 2021

(54) METHOD FOR OPERATING A DEVICE FOR ADDITIVE MANUFACTURE OF A THREE-DIMENSIONAL OBJECT

(71) Applicant: TRUMPF Laser- und Systemtechnik GmbH, Ditzingen (DE)

(72) Inventors: Frederik Schaal, Fellbach (DE); Sven Schweikert, Stuttgart (DE); Marc Gronle, Stuttgart (DE); Nicolai Essig, Renningen (DE)

(21) Appl. No.: 17/313,010

(22) Filed: May 6, 2021

Related U.S. Application Data
(63) Continuation of application No. PCT/EP2019/080111, filed on Nov. 4, 2019.

(30) Foreign Application Priority Data
Nov. 8, 2018 (DE) 10 2018 127 989.2

(51) Int. Cl. B22F 10/85; B33Y 10/00; B33Y 30/00; B33Y 50/02; B22F 10/28; B22F 12/90

(52) U.S. Cl. CPC B22F 10/85; B33Y 10/00; B22F 12/90; B33Y 50/02; B22F 10/28; B33Y 30/00

(57) ABSTRACT

A method for operating a manufacturing device for the additive manufacture of a three-dimensional object, by the layered application and selective solidification of a building material in a building area lying in a working surface, includes directing, by a first scanning unit of the manufacturing device, a detection region of a first sensor unit onto at least one first partial region of a test body region without the first scanning unit directing a beam onto the test body region. The first sensor unit is assigned to the first scanning unit. The method further includes irradiating at least part of the test body region with a beam directed onto the test body region by a second scanning unit of the manufacturing device and evaluating measurement signals detected by the first sensor unit.

### CROSS REFERENCE TO RELATED APPLICATIONS

This application is a continuation of International Application No. PCT/EP2019/080111 (WO 2020/094576 A1), filed on Nov. 4, 2019, and claims benefit to German Patent Application No. DE 10 2018 127 989.2, filed on Nov. 8, 2018. The aforementioned applications are hereby incorporated by reference herein.

### FIELD

The present disclosure relates to a method for operating a device for the additive manufacture of a three-dimensional object by the layered application and selective solidification of a, in particular, powdery building material. Such devices for the additive manufacture of a three-dimensional object have an object formation chamber in which the object to be manufactured is created step by step. A work surface is provided in the object formation chamber, which work surface has a building area for manufacturing the three-dimensional object. The method relates to manufacturing devices that have at least two beam sources and two scanning units. The scanning units are designed and arranged to direct a beam of the respective first or second beam source, controlled by the respective first or second scanning unit, onto different target points on the building area. In other words, the respective beam can be guided or directed to different points on the building area via the scanning units. A first sensor unit is assigned to at least the first scanning unit. The detection region of the first sensor unit is directed to the target point of the first scanning unit via the first scanning unit. The optical beam guidance can also be such that the detection region of the first sensor unit is directed via the first scanning unit onto a region upstream or downstream of the first target point in the direction of movement of the first target point. In other words, when the first beam source is activated, the detection region of the first sensor unit detects the region on the building area at which the scanning unit directs this beam. When the first beam source is deactivated, the first sensor unit accordingly detects that region on the building area at which the scanning unit would direct this beam.

### BACKGROUND

The first and second scanning units are each designed and arranged or operated in such a way that they move their target points independently of one another. In other words, a change in the position of the first scanning unit does not change the position of the target point of the second scanning unit and vice versa. The independent movement of the target points makes it possible, for example, to apply radiation to different points on the building area independently of one another (first and second beams can be moved independently).

Manufacturing devices with two or more beam sources also means manufacturing devices which have a single device for actually generating a beam, this beam in turn being divided into a plurality of partial beams, for example by means of a beam splitter. The individual partial beams of the split beam then represent the multiple beam sources.

So-called “selective laser sintering” (SLS) or “selective laser melting” (SLM) processes are known for the additive manufacture of a three-dimensional object. For this purpose, the powdery material, for example metal or ceramic powder, is irradiated in the object formation chamber with electromagnetic radiation from the above-mentioned beam sources, in particular with laser light. The two beam sources therefore mean sources of electromagnetic radiation which are suitable for melting or sintering the building material, i.e. they provide radiation of sufficient power and suitable wavelength. A thin layer of powder is applied to the building area of the chamber, which is sintered or melted with the laser light to manufacture the object. The manufacture of the object takes place step by step; powder layers are applied in succession and are each sintered or melted. Between the manufacturing steps, the powdery material is applied or spread onto the building platform with an application device, for example a wiper, a roller, a brush, or a blade.

### SUMMARY

In an embodiment, the present disclosure provides a method for operating a manufacturing device for the additive manufacture of a three-dimensional object by the layered application and selective solidification of a building material in a building area lying in a working surface. The method includes directing, by a first scanning unit of the manufacturing device, a detection region of a first sensor unit onto at least one first partial region of a test body region without the first scanning unit directing a beam onto the test body region. The first sensor unit is assigned to the first scanning unit. The method further includes irradiating at least part of the test body region with a beam directed onto the test body region by a second scanning unit of the manufacturing device and evaluating measurement signals detected by the first sensor unit. The first and second scanning units of the manufacturing device are designed and arranged to direct a beam of a respective first or second beam source controlled by the respective first or second scanning unit onto different target points on the building area. The first scanning unit is configured to direct the detection region of the first sensor unit to a target point of the first scanning unit.

### BRIEF DESCRIPTION OF THE DRAWINGS

Subject matter of the present disclosure will be described in even greater detail below based on the exemplary figures. The invention defined by the following claims is not limited to the exemplary embodiments. All features described and/or illustrated herein can be used alone or combined in different combinations. The features and advantages of various embodiments will become apparent by reading the following detailed description with reference to the attached drawings, which illustrate the following:

FIG. 1 is a schematic view of a manufacturing device for the additive manufacturing of a three-dimensional object on which a method according to an embodiment can be carried out;

FIG. 2 is a schematic plan view of the building area of the manufacturing device;

FIG. 3 is a schematic top view of the test body region of the building area of the manufacturing device, one possible type of procedure being illustrated; and.

FIG. 4 is a schematic top view of the test body region of the building area of the manufacturing device, illustrating a further possible type of procedure.

### DETAILED DESCRIPTION

The present disclosure provides a method for operating the above-mentioned manufacturing device that allows for precise process control with little expenditure on equipment.

The method includes the following steps:

Step 1: Directing the detection region of the first sensor unit by means of the first scanning unit onto at least one first partial region of a test body region without the first scanning unit directing a beam onto the test body region. The detection region of the first sensor unit is thus arranged in or in an intersection with a test body region via the first scanning unit. The first beam source is deactivated, or a beam emanating from it is deflected or blocked in such a way that it is not directed onto the test body region via the first scanning unit.

Step 2: Irradiating at least a part of the test body region with a beam which is directed onto the test body region via the second scanning unit. The second beam source is therefore activated temporarily in any case and its beam is guided onto the test body region via the second scanning unit.

Optionally, in a step 3, measurement signals detected by the first sensor unit and/or by further sensor units can be evaluated. The detected measurement signals can be compared, for example, with measurement signals from an identical reference building process. Alternatively or additionally, it is also conceivable to compare the detected measurement signals with simulation results. The detected measurement signals can also be compared with measurement signals that were detected at other locations, for example on the test body, during the building process.

The method thus relates to the monitoring of a building process of a test body or the collection of measurement data while building it. A test body is a built object that does not represent a component intended for later use, but merely serves, for example, for quality control or for adjusting the manufacturing device used. A test body can, for example, be submitted to an analysis after building it. Typically, such an analysis is destructive, for example a metallurgical analysis can be carried out. For example, the porosity can be determined using micrographs.

Methods are known from the prior art which provide a dedicated, i.e. spatially fixed, test body region which is monitored or observed by means of a dedicated and permanently installed sensor that has a fixed detection or monitoring region. Such a permanently installed sensor thus has a detection region spatially fixed on the test body region. Correspondingly, such a sensor is only used when a corresponding test body is built. While components are being built, i.e. parts that are intended for later use, this sensor is deactivated and has no function. If the space provided for the test body is required for a regular component, in return no test body can be built there, although there might possibly be sufficient space at another location. Since predominantly components are manufactured during the operation of the manufacturing device and, in comparison, only rarely test bodies, the sensor assigned to the test body region is hardly used in comparison to the total running time of the manufacturing device.

The method described herein now makes it possible to use a sensor that is not only used when a test body is being built, but is also used or can be used when the regular components are created. As a result, the manufacturing device is used more efficiently or fewer components are required for the manufacturing device. At the same time, however, the method also offers greater flexibility and the possibility of building test bodies at will, so that, for example, the monitoring of the processes carried out can be carried out more precisely and with more test bodies, for example.

In one embodiment, the method can be carried out by a manufacturing device in which a second sensor unit is assigned to the second scanning unit. The detection region of the second sensor unit is directed to the target point of the second scanning unit via the second scanning unit. The optical beam guidance can also be such that the detection region of the second sensor unit is directed via the second scanning unit onto a region upstream or downstream of the second target point in the direction of movement of the second target point. In other words, corresponding to the first sensor unit and the first scanning unit, when the second beam source is activated, the detection region of the second scanning unit detects the point on the building area to which the scanning unit guides the beam of the second beam source when the second beam source is activated. During the irradiation of the part of the test body region with the beam which is directed onto the test body region via the second scanning unit, the second sensor unit can detect the target point of the second scanning unit. The building process in the test body region carried out by irradiation by means of the second scanning unit or the second beam source can therefore be observed in this variant by means of the first and the second sensor unit. In particular, this observation can take place while the target point of the second scanning unit is being moved over the test body region. The detection region of the first sensor unit can be held stationary or moved.

As described above, the two sensor units are each so-called “on-axis” sensors, the detection region of which in any case partially extends over the same optical path as the beam from the respective beam source. In order to prevent the measurement results from being superimposed with the radiation from the beam source, a beam splitter or some other device for filtering out or deflecting the radiation from the beam source can be arranged in the optical corridor of the sensor units, so that only radiation emanating from the building area is detected by the sensor units.

The detection region of the first sensor unit can also be moved by means of the first scanning unit. For example, the detection region of the first sensor unit can be moved in such a way that it always extends around the target point of the second scanning unit. However, it is also possible to move the detection region of the first scanning unit in advance of the target point of the second scanning unit or to move it following the target point of the second scanning unit. In the sense of the present disclosure, this means that the building process can be controlled or regulated by carrying along the monitoring region (on, before, or after the target point). The detection region can therefore be held at a, for example constant, distance in front of or behind the target point and can be moved along with it. It is also possible to keep the detection region of the first sensor unit stationary, i.e. unmoved. The detection region can be arranged in such a way that the target point of the second scanning unit is moved through the detection region of the first sensor unit while building the test body. The detection region of the first sensor unit can, however, also be arranged and held stationary in such a way that the target point of the second scanning unit is not guided through the detection region of the first sensor unit during the irradiation. For example, the conduction of the heat introduced by the irradiation in the test body can be determined in this way. In this way, for example, conclusions can be drawn about the thermal conductivity of different regions in the test body. A corresponding guidance of the detection region of the first sensor unit and the target point of the second scanning unit when building an actual component, i.e. a built object that is not provided exclusively for test purposes, is also within the meaning of the present disclosure. For example, the thermal conductivity of the component can thus be determined and compared with known values or values of the test body.

For example, a component and a structurally identical test body can be built and both can be examined according to the method by carrying out a corresponding guidance of the detection region of the first sensor unit and the target point of the second scanning unit when building the actual component and the test body. This can also be carried out simultaneously with separate first sensor units and second scanning units. It is possible to draw conclusions about the actual components from the results of the (destructive) examination of the test body. The data of the test body and/or the component can then in turn be compared with other components that are subsequently or parallel built.

With the method described herein, it is possible to compare the values detected while building the test body with reference values. The reference values can originate, for example, from the building process of a test body or a component. In the context of the present disclosure, the building process of the test body can be controlled or regulated by comparing the detected values with the reference values. For example, it can be provided that a correction step is carried out if the detected values deviate from the reference values. It is also conceivable that if the detected values deviate from the reference values, an adaptation of the process control parameters of the building process of the test body is carried out.

In the context of the present disclosure, the values detected during the process of building the test body can also be used as reference values for a building process of a component. The building process of the component can be controlled or regulated based on a comparison of the values detected while building with the reference values. The reference values can also be used to control the building process of the component, i.e. to detect a deviation from the desired sequence. The control or regulation can take place as described above. By comparing the detected values with the reference values, the process control parameters can be adapted, for example. For example, it can be provided that a correction step is carried out if the detected values deviate from the reference values. It is also conceivable that if the detected values deviate from the reference values, an adaptation of the process control parameters of the building process of the test body is carried out.

In one embodiment, the method can be carried out by a manufacturing device which has a third scanning unit and a third sensor unit and possibly a third beam source. This allows for more detailed measurements to be carried out. The third scanning unit can optionally be designed and arranged to direct a beam of a third beam source controlled by the third scanning unit onto different target points on the building area. It can therefore be designed in accordance with the first and/or second scanning unit. When using such a manufacturing device during the irradiation by means of the second scanning unit, the detection region of the third sensor unit can be directed by means of the third scanning unit onto at least one second sub-region of the test body region, possibly without the third scanning unit directing a beam onto the test body region. This results in an additional monitoring option and further information that provides information about the built object or the building process can be collected.

During the irradiation by means of the second scanning unit, the detection region of the first sensor unit and the third sensor unit can intersect. It is also possible for the two detection regions to be arranged concentrically to one another. The detection regions can in particular be designed to be circular. It is also possible for the detection region of one of the sensor units to be, in particular, adjusted in such a way that it completely contains the detection region of the other sensor unit. For this purpose, for example, one of the detection regions can be focused, for example by means of focusing optics assigned to the respective scanning unit, and the other detection region can be defocused accordingly so that it detects a larger area.

The irradiation by means of the second scanning unit can be carried out in such a way that initially powdery building material (at least partially, preferably completely) melts and then solidifies. The actual test body is built thereby. For this purpose, the irradiation can in particular be carried out with such an intensity that the building material melts. Correspondingly, the type of radiation, for example laser radiation, is selected in such a way that it is able to transmit sufficient energy to the building material. In this type of process management, the actual building process of the test body is observed or detected by means of the sensor unit or sensor units.

The irradiation by means of the second scanning unit can take place following an irradiation process in which powdery building material was initially melted and then solidified, the irradiation with the beam from the second scanning unit taking place, in particular in a pulse-like manner, on the already solidified part of the building material in the test body region. In other words, the implementation of the method can relate to an already built part of the test body. In this type of procedure, a part of the test body that has already been built is exposed to radiation. It can be provided that the irradiation is carried out, in particular with such an intensity, that the already solidified building material does not melt. In other words, as a result of the irradiation in this type of procedure, part of the test body that has already been built is heated by means of a defined amount of energy supplied depending on radiation. For example, the heat conduction in the built test body can then be checked or determined via the monitoring or detection by means of the sensor unit or sensor units. Deviations from the expected thermal conductivity can, for example, be an indicator of inclusions or the formation of cavities. In the variants just described in which an already solidified part of the test body is irradiated, the detection region of the first and/or possibly the third sensor unit can detect a solidified region of the building material that is spaced from the irradiated part. There can be a direct connection of solidified material between the irradiated and the detected region of the test body. In particular, the direct connection can extend in the horizontal plane in which the irradiation is carried out. In such a configuration, for example, the thermal conductivity can be measured in portions of the test body.

As already mentioned above, the method can include the evaluation of the detected measurement data. The measurement signals detected by the first sensor unit and/or possibly the third sensor unit can be compared in the context of an evaluation, for example, with measurement signals from an identical measurement from a previous building process of a test body. It is also conceivable that measurement signals from different locations on the test body are compared with one another. In particular, it is possible for the thermal conductivity behavior in different portions of the test body to be compared with one another. To determine the thermal conductivity, as suggested above, the irradiation of an already solidified part of the test body can take place and a portion of the test body spaced apart from the irradiated part can be detected by the sensor unit(s).

It can be provided that the method comprises building two test bodies. The irradiation by means of the beam of the second scanning unit can be identical in each case when building the two test bodies. In other words, the building process of the two test bodies can take place with exactly the same guidance of the beam of the second scanning unit. The detection by means of the second sensor unit and/or possibly the third sensor unit can be identical, at least temporarily, preferably completely, when building the two test bodies. In other words, the detection regions of the respective sensor unit can run through the same movement patterns when building the two test bodies or be directed to the same positions in a stationary manner. A corresponding method can then include a comparison of the measured values determined by the sensor units with regard to the two building processes of the test bodies. When building two test bodies, however, it is also conceivable that the sensor units initially run through a specific movement pattern of the detection regions or are positioned in a specific position during the building process and, in a further step, the detected measurement signals are used as part of a simulation. When building the second test body, the detection regions can then be guided in a different movement pattern or placed in a different position in order to verify the results of the simulation. This is also possible when using a sensor unit.

The method can comprise the metallurgical analysis of a test body built in the test body region. In particular, this is the test body whose building process was detected by the sensor units.

The method can in particular be carried out in such a way that the test body region lies spatially between two components that are also built on the building area or the building process of the test body takes place spatially between two components.

The test body built within the scope of the method can for example comprise a strip-shaped pattern or be a strip-shaped pattern. In particular, it is possible for lines that run parallel to one another to be solidified within a test body region, which can for example be of circular design. The detection region of the first sensor unit can for example be arranged in the center of the test body region, with solidified lines running through the detection region of the first sensor unit during the building process of the test body. In this example, the detection region of the first sensor unit can be held stationary in this position during the entire building process of the test body. The detection region of the third sensor unit can, for example, be arranged next to the detection region of the first sensor unit. However, it is also conceivable that the detection region of the third sensor unit is adjusted to be larger than that of the first sensor unit, for example by means of a corresponding focusing or defocusing. For example, the detection region of the third sensor unit can be arranged around the detection region of the first sensor unit so that it contains it completely. For example, the two detection regions can be aligned circularly and concentrically with one another. The sensor unit(s) can detect the cooling and heating behavior in the test body. The detected data can be compared with the building process of an identical and earlier test body. The stationary positioning of the detection region allows for conclusions to be drawn about the heat balance or the thermal conductivity in the test body that has been built through appropriate evaluation.

It is also within the scope of the present disclosure to irradiate the test body in a pulse-like manner, the energy input being such that the test body only heats up and does not melt. The first sensor unit can be used to detect the heating and/or cooling behavior in the irradiated or an adjacent region. From this, on the one hand, the time constant of the heating/cooling process or the system response of a specific region of the component or test body can be determined.

The sensor units can detect thermal radiation emitted by the test body region and can be pyrometers, for example. The sensor unit can in particular comprise photodiodes. Flat sensors such as cameras (or thermal imaging cameras) can also be used. However, further sensors can also be bolometers. In particular, the sensor units can detect the temperature in the respective detection region. In particular, the development of the temperature over time can be detected in the respective detection region. The warming-up and/or cooling-down behavior can be detected. To detect the warming-up behavior, the temperature development from the beginning of the irradiation is detected. To detect the cooling-down behavior, the temperature development after the end of the irradiation is detected. It is possible to observe the initial phase of cooling or to carry out the observation until the temperature in the detection region has fallen back to the initial value.

In an evaluation step of the method, it is, in particular, possible to determine the time constant for a heated target point. The time constant corresponds to the product of the thermal resistance and the thermal capacity, the thermal capacity in turn corresponding to the product of the specific thermal capacity and volume.

In the method, the first and optionally third beam sources are each inactive, while the second beam source directs a beam onto the test body region and the first and optionally third sensor unit each detect or observe a part of the test body region. The second beam source (scanning unit and beam source) can use the same sensors (sensor unit) as the beam path 1 and 3 (sensor units 1 and 3 with scanning units 1 and 3). The sensor system of the beam path 2 can also be activated, so that the heat signal that is moved with it can also be merged with the other information sources and evaluated as a whole within the framework of a data fusion.

Following the (partial) building process of the test body, the first and third scanning units with the sensor units assigned to them can be used to build components and to observe this building process. By using the method, the outlay in terms of equipment is correspondingly low, since sensor units that are already present on the first or third scanning units are used to observe the test body region instead of providing a separate test body region sensor that is only used when the test body is being built. Correspondingly, it can also be part of the method that, following the building process and observation of the test body and/or before the building process and observation of the test body by means of the first and/or second scanning unit, a beam is directed onto the building area in order to build a component.

Further details and advantageous designs can be found in the following description, on the basis of which embodiments of the present disclosure are described and explained in more detail.

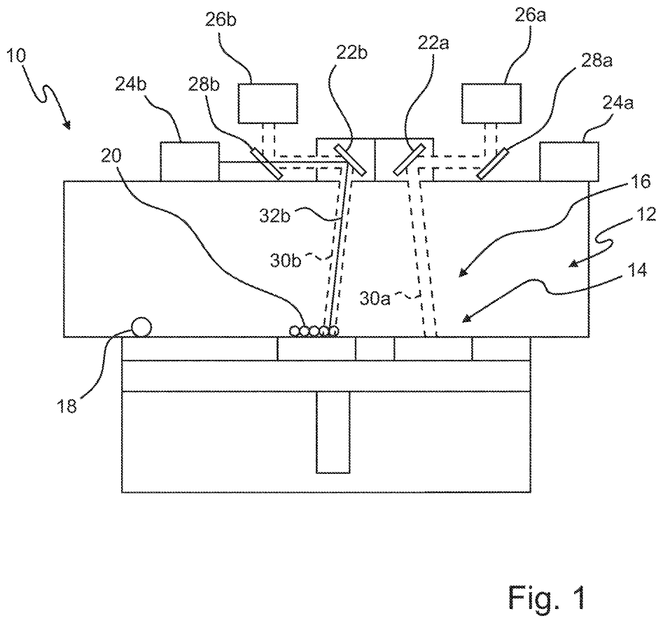

FIG. 1 shows a manufacturing device 10 on which a method according to an embodiment is carried out. The apparatus 10 has an object formation chamber 12. A work surface 14 having a building area 16 is arranged in the object formation chamber 12. An application device 18 is also arranged in the object formation 12, which in the present example is in the form of a roller, but can also be in the form of a doctor blade, for example.

Powdery building material 20, which in the present case is arranged in layers on the building area 16, is shown only schematically and in certain regions, the illustration being greatly enlarged. For each layered building process, between 1 μm and 200 μm of powdery building material 20 is typically distributed in layers over the building area 16 by means of the application device 18.

In the present example, the manufacturing device comprises two scanning units 22. A first beam source 24a is assigned to the first scanning unit 22a and a second beam source 24b is assigned to the second scanning unit 22b. Correspondingly, a respective sensor unit 26 and a beam splitter 28 are assigned to the respective scanning units 22. On the one hand, a detection region 30 of the sensor units is guided via the beam splitter 28 to the scanning units 22 and, on the other hand, a respective beam 32 of the radiation sources 24 is coupled into the same optical path.

The first radiation source 24a is shown in FIG. 1 in the deactivated state, so that no beam 32a emanates from it.

The second radiation source 24b, on the other hand, is shown in FIG. 1 in the activated state, so that a second beam 32b emanates from it. The beam 32b is directed via the second scanning unit 22b onto a test body region 34 of the building area 16.

The detection regions 30 of the sensor units 26 are also directed to the test body region 34 of the building area 16 via the respective scanning units 22. The detection region 30b of the second sensor unit 26b is directed to a target point 36b of the second scanning units 22b. The target point 36 is that region on the building area 16 to which the scanning unit 22 guides the corresponding beam 32. In the case of the first scanning units 22a, the detection region 30a of the first sensor unit 26a is also directed to the corresponding target point 36a of the first scanning units 22a, the target point 36a corresponding to the region on the building area 16 to which the scanning unit 22 guides the corresponding beam 32 as soon as the first beam source 24a is activated.

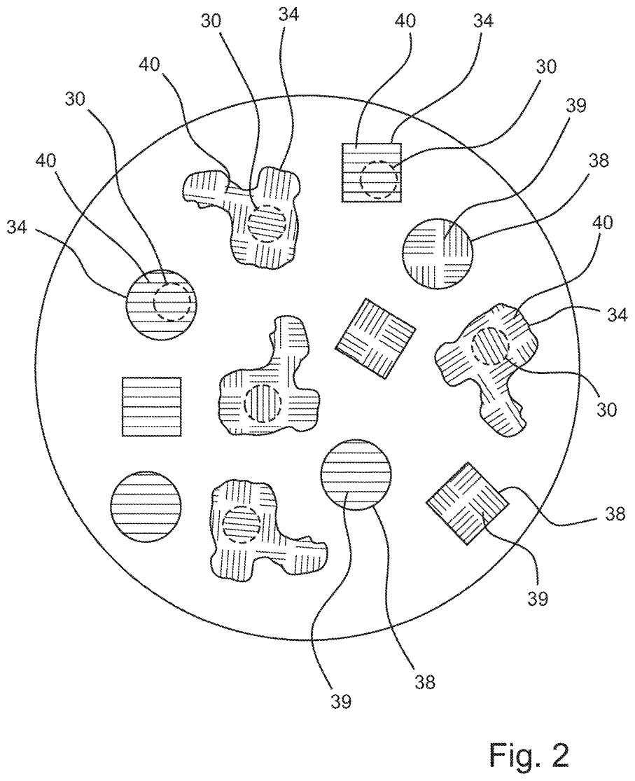

FIG. 2 shows the building area 16 of the manufacturing device 10 in a schematic plan view.

Test body regions 34 and component regions 38 are arranged on the building area 16. In the component regions 38, components 39, i.e. parts that are intended for later use, are built. In contrast, test bodies 40 are built in test body regions 34. The test bodies 40 are only used for test purposes and are not intended for any later use. However, they can, for example, be analyzed metallurgically after their building process and possibly after a measurement by subsequent irradiation. For example, micrographs of the test bodies 40 can be created in order to analyze their structure. The monitoring carried out on the test bodies can also be carried out on components 39. If the same measured values are obtained and the component and test body are built accordingly, the results of the (destructive) examination of the test body can be transferred to the component. If it turns out, for example, that these are OK or free of errors, it can be assumed that the actual components are also OK.

As can be clearly seen in FIG. 2, the use of a sensor unit in combination with a scanning unit makes it possible to arrange the test body regions 34 at virtually any points on the building area 16.

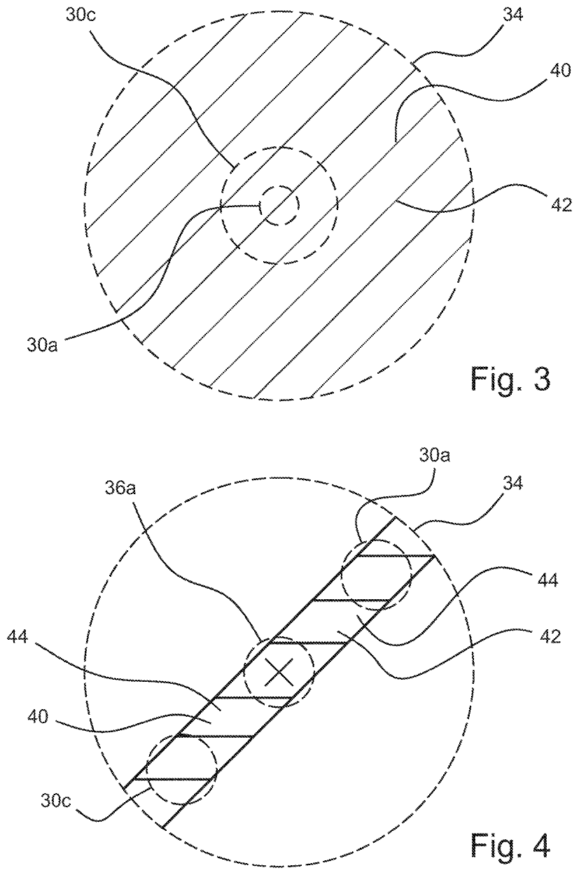

One possible way of carrying out the process is illustrated schematically in FIG. 3. In a manner similar to FIG. 2, a plan view of the building area 16 is shown, but the illustration is limited to the test body region 34 or one of the test body regions 34.

In the variant of the method shown in FIG. 3, a strip-shaped pattern is built as test body 40 in one of test body regions 34. The test body region 34 is circular and individual lines 42 are solidified, each running parallel to one another. For this purpose, the target point 36b of the second scanning unit 22b is moved along the desired lines over the test body region 34 when the second beam source 24b is activated. The radiation intensity of the beam source 24b is coordinated with the speed of movement of the target point 36b predetermined by the scanning unit 22b in such a way that the powdery building material 20 melts when the target point 36b is moved over the building material 20. After the target point 36b has passed a specific point, the melted building material 20 cools down again and solidifies, as a result of which the test body 34 is built in layers. The second sensor unit 26b can be activated and observe the respective formation of the melt pool. However, this is optional.

In the procedure illustrated in FIG. 3, the detection region 30a of the first sensor unit 26a is arranged in the center of the test body region 34. The detection region 30c of the third sensor unit 26c is defocused in the present case and is therefore adjusted to be larger than that of the first sensor unit 26a. The detection region 30c of the third sensor unit 26c is arranged around the detection region 30a of the first sensor unit 26a so that it completely contains it. Both detection regions 30 are circular and aligned concentrically to one another. During the building process of the test body 40, the target point 36b runs partially through the two detection regions 30a and 30c.

In the present example, both detection regions 30a and 30c are held stationary in the positions shown in FIG. 3 during the entire building process of the test body 40.

In the configuration just described, the sensor unit(s) 26 can detect the cooling and heating behavior of the building material 20 during the building process of the test body 40. In an evaluation step of the method, the detected data can be compared, for example, with the building process of an identical and earlier test body 40, the building process of which was measured in the same way.

In this sense, FIG. 3 also illustrates a procedure in which the building process of the test body 40 shown in FIG. 3 and the detection illustrated in FIG. 3 by the sensor units 26 are carried out twice in succession and the respective measurement results of the two building processes of the test body 40 are compared together in one evaluation step.

In FIG. 4, a further possible way of carrying out the method is schematically illustrated, a plan view of the test body region 34 of the building area 16 of the manufacturing device 10 being shown again.

The irradiation by means of the second scanning unit 22b within the scope of the method can, as explained in connection with FIG. 3, be carried out in such a way that the initially powdery building material 20 solidifies, typically in that it melts and then hardens and solidifies. The actual test body 40 is thus built here. With this type of method management, the actual building process of the test body 40 is observed or detected by means of the sensor unit(s) 26.

A variant of the method is illustrated in FIG. 4 in which the irradiation by means of the second scanning unit 22b takes place following an irradiation process in which the initially powdery building material 20 has already solidified. The irradiation within the scope of the method can then take place with the beam 32b of the second scanning unit 22b on the already solidified part of the building material 20 in the test body region 34, i.e. on the test body 40 that has already been built. In this type of procedure, the irradiation can in particular be carried out in a pulse-like manner.

The irradiation can be carried out in such a way, in particular with such an intensity and duration, that the already solidified building material 20 does not melt. In other words, as a result of the irradiation in this type of procedure, a part of the test body 40 that has already been built is heated by means of a defined amount of energy supplied based on radiation. The heat conduction in the built test body 40 can then be checked or determined via the monitoring or detection by means of the sensor unit(s) 26.

In the example of FIG. 4, a line-shaped test body 40 was first built. The test body 40 is shown in FIG. 4 as a hatched area. To carry out the method, the target point 36b is then aimed at the test body 40 that has already solidified. The detection regions 30a and 30c of the respective first and third sensor units 26a and 26b are also directed onto the already solidified test body 40, however, in the present case the detection regions 30 are arranged at a distance from the target point 36b of the second scanning unit 22b. During the irradiation, the target point 36b of the second scanning unit 22b is not moved. The detection regions 30a and 30c of the first and third sensor units 26a, 26c are also not moved while the method is being carried out. A beam 32b is then emitted in a pulse-like manner to the target point 36b via the second beam source 24b. The duration and intensity of the irradiation are known so that the amount of energy delivered to the test body 40 can be determined. The sensor units 26 now detect the heat profile in the test body 40. In this case, the sensor unit 26 captures data from the test body 40 over a longer period of time than the irradiation lasts.

In the example illustrated in this case, there is a direct connection 44 made of solidified building material 20 between the irradiated and the detected region or region of the test body 40 observed by the sensor units 26. In an outward step, for example, conclusions can be drawn about the thermal conductivity behavior in portions of the test body 40 via the measurement signals detected by the sensor units 26.

The measurement signals detected by the first sensor unit and/or possibly the third sensor unit 26a, 26c can be compared in the context of an evaluation, for example, with measurement signals detected in the same way from a previous building process of a test body 40.

While subject matter of the present disclosure has been illustrated and described in detail in the drawings and foregoing description, such illustration and description are to be considered illustrative or exemplary and not restrictive. It will be understood that changes and modifications may be made by those of ordinary skill within the scope of the following claims. In particular, the invention defined by the following claims may cover further embodiments with any combination of features from different embodiments described above and below.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A method for operating a manufacturing device for the additive manufacture of a three-dimensional object by the layered application and selective solidification of a building material in a building area lying in a working surface, the method comprising:
directing, by a first scanning unit of the manufacturing device, a detection region of a first sensor unit onto at least one first partial region of a test body region without the first scanning unit directing a beam onto the test body region, the first sensor unit being assigned to the first scanning unit,
irradiating at least part of the test body region with a beam directed onto the test body region by a second scanning unit of the manufacturing device, and
evaluating measurement signals detected by the first sensor unit,
wherein the first and second scanning units of the manufacturing device are designed and arranged to direct a beam of a respective first or second beam source controlled by the respective first or second scanning unit onto different target points on the building area, and
wherein the first scanning unit is configured to direct the detection region of the first sensor unit to a target point of the first scanning unit.

2. The method according to claim 1, wherein the second scanning unit is assigned a second sensor unit, wherein the second scanning unit is configured to direct a detection region of the second sensor unit to a target point of the second scanning unit.

3. The method according to claim 2, further comprising directing, by the second scanning unit, the detection region of the second sensor unit to the target point of the second scanning unit during irradiation of the part of the test body region with the beam directed onto the test body region by the second scanning unit, and
detecting, by the second sensor unit, the target point of the second scanning unit.

4. The method according to claim 3, wherein the detecting, by the second sensor unit, the target point of the second scanning unit is performed while the second scanning unit moves the target point of the second scanning unit over the test body region.

5. The method according to claim 1, further comprising holding the detection region of the first sensor unit stationary during the irradiation of the part of the test body region by the beam directed onto the test body region by the second scanning unit.

6. The method according to claim 5, further comprising moving, by the second scanning unit, the target point of the second scanning unit over the test body region during the irradiation of the part of the test body region by the beam directed onto the test body region by the second scanning unit.

7. The method according to claim 6, wherein the moving, by the second scanning unit, the target point of the second scanning unit over the test body region during the irradiation of the part of the test body region by the beam directed onto the test body region by the second scanning unit comprises moving the target point of the second scanning unit through the detection region of the first sensor unit.

8. The method according to claim 1, wherein the manufacturing device includes a third scanning unit and a third sensor unit, wherein the third scanning unit is designed and arranged to direct a beam of a third beam source onto different target points on the building area, the method further comprising directing, by the third scanning unit, a detection region of the third sensor unit onto at least one second partial region of the test body region during the irradiation of the part of the test body region by the beam directed onto the test body region by the second scanning unit.

9. The method according to claim 8, wherein the detection region of the first sensor unit and the third sensor unit intersect during the irradiation of the part of the test body region by the beam directed onto the test body region by the second scanning unit, wherein a respective detection region of one of the first sensor unit and the third sensor unit is adjusted such that it completely contains a respective detection region of the other of the first sensor unit and the third sensor unit.

10. The method according to claim 1, wherein the irradiation of the part of the test body region by the beam directed onto the test body region by the second scanning unit is carried out in such a way that initially powdery building material solidifies.

11. The method according to claim 1, wherein the irradiation of the part of the test body region by the beam directed onto the test body region by the second scanning unit takes place following an irradiation process in which initially powdery building material was solidified, the irradiation of the part of the test body region by the beam directed onto the test body region by the second scanning unit taking place in a pulse-like manner and onto the already solidified part of the building material in the test body region,
wherein the pulse-like irradiation is carried out in such a way that the already solidified building material does not melt.

12. The method according to claim 11, wherein the at least one first partial region of the test body region onto which the detection region of the first sensor unit is directed is a solidified region of the building material.

13. The method according to claim 12, wherein the solidified region of the building material is, in particular, spaced apart from a pulse-like irradiated part and is directly connected thereto via solidified building material.

14. The method according to claim 13, wherein the measurement signals detected by the first sensor unit are compared with measurement signals from an identical measurement from a previous building process of a test body.

15. The method according to claim 1, the method comprising building two test bodies, wherein the irradiation by the beam of the second scanning unit is identical in each case when building the two test bodies, and wherein the detection by the second sensor unit is in each case, at least temporarily identical.

16. The method according to claim 1, further comprising performing metallurgical analysis of a test body built in the test body region.

17. The method according to claim 1, further comprising comparing values detected while building a test body including the test body region with reference values and controlling or regulating the building process of the test body based on the comparing the detected values with the reference values.

18. The method according to claim 1, wherein values detected during the building process of a test body including the test body region are used as reference values and, in a further building process, the reference values are compared with values detected during the further building process, the further building process being controlled or regulated based on the comparison of the values detected during the further building process with the reference values.
